(19) United States
(12) Patent Application Publication
(10) Pub. No.: US 2014/0357277 A1
(43) Pub. Date: Dec. 4, 2014

(54) METHOD AND NODE FOR INCREASING RADIO CAPACITY IN ISOLATED AREA

(71) Applicants: Henrik Asplund, Stockholm (SE); Bo Hagerman, Tyreso (SE); Markus Ringström, Stockholm (SE)

(72) Inventors: Henrik Asplund, Stockholm (SE); Bo Hagerman, Tyreso (SE); Markus Ringström, Stockholm (SE)

(73) Assignee: Telefonaktiebolaget L M Ericsson (publ), Stockholm (SE)

(21) Appl. No.: 14/372,812

(22) PCT Filed: Jan. 26, 2012
(86) PCT No.: PCT/SE2012/050077

§ 371 Date: Jul. 17, 2014

(51) Int. Cl. H04W 36/00; H04W 16/14

(52) U.S. Cl. CPC H04W 36/0061; H04W 36/0083; H04W 16/14; H04W 88/10
USPC 455/437; 455/552.1

(57) ABSTRACT

Some embodiments of the present invention relate to a method in a radio network node of a communications system, for controlling a user equipment's transmission in cells of a first frequency band. The cells of the first frequency band are intended only for user equipment in an isolated area. The method comprises receiving a measurement report from the user equipment comprising a list of measured cells. The list of measured cells comprises cells of the first frequency band, and cells of a second frequency band providing coverage both in the isolated area and in an area outside the isolated area. The method also comprises allowing the user equipment to transmit in one of the cells of the first frequency band, if all cells in the list of measured cells provide coverage only in the isolated area.

### TECHNICAL FIELD

The disclosure relates to control of a user equipment's transmission in cells of a frequency band which is intended only for user equipment in an isolated area.

### BACKGROUND

The Universal Mobile Telecommunication System (UMTS) is one of the third generation mobile communication technologies designed to succeed the Global System for Mobile communications (GSM). Long Term Evolution (LTE) is a project within the 3^{rd} Generation Partnership Project (3GPP) to improve the UMTS standard to cope with future requirements in terms of improved services such as higher data rates, improved efficiency, and lowered costs.

In a UMTS or LTE radio access network, a user equipment (UE) is wirelessly connected to a radio base station (RBS) commonly referred to as a NodeB (NB) in UMTS, and as an evolved NodeB (eNodeB or eNB) in LTE. An RBS is a general term for a radio network node capable of transmitting radio signals to a UE and receiving signals transmitted by a UE.

FIG. 1a illustrates a cellular network with an RBS 101 that serves a UE 103 located within the RBS's geographical area of service, called a cell 105. In UMTS, a Radio Network Controller (RNC) 106 controls the RBS 101, and is, among other things, in charge of management of radio resources in cells for which the RNC is responsible. The RNC is in turn also connected to the core network. In GSM, the node controlling the RBS 101 is called a Base Station Controller (BSC) 106. FIG. 1b illustrates a radio access network in an LTE system. An eNB 101a serves a UE 103 located within the RBS's geographical area of service, called a cell 105a, and is directly connected to the core network. The eNB 101a is also connected to a neighboring eNB 101b serving another cell 101b. The eNBs 101a, 101b, are connected to each other via an X2 interface.

Most people today demand ubiquitous voice service and internet access through their smart-phone, which is an example of a UE. However, the subway is one example of an isolated environment or area where it is a challenge to provide coverage and capacity. Consequently, it is sometimes impossible to access the internet in the subway during rush hours. A fundamental problem with providing good service in the subway is that the distribution of demand is difficult to meet. When there is no train passing, the demand is low, but when a train passes the demand can be high within a small geographical area.

A well-known solution for providing coverage in the subway is by deploying leaky cables. This guarantees good coverage in the subway system. However, capacity may not be good enough to support the high demands from a full subway train, even if all available carrier frequencies are used. A possible solution would be to deploy MIMO, which however requires the roll-out of additional leaky cables in all tunnels, which is a difficult and costly operation. Areas inside big office buildings are also examples of similar isolated areas, where the demand for capacity increases dramatically during day time.

The idea of reusing unlicensed frequency bands, or frequency bands used for other services in areas that provide a shielded or isolated environment, such as in buildings, has been disclosed as a possibility to increase capacity in the article “Reusability of Primary Spectrum in Buildings for Cognitive Radio Systems”, by Meng-Jung Ho, Steven M. Berber, and Kevin W. Sowerby, University of Auckland, NEW ZEELAND, 2011. However, if the UEs using the unlicensed frequency bands are mobile, there is a great risk that the UEs generate forbidden interference outside the isolated area as they are moving towards the borders of the isolated area. The risk of interference is especially high when the mobile UEs are moving with a high speed, e.g. in the case of UEs used in a subway train.

### SUMMARY

Hence, there is a need for a procedure that overcomes at least some of the drawbacks described above.

It is therefore an object to address some of the problems outlined above, and to provide a solution for increasing capacity in isolated areas by using unlicensed frequency bands, without risking unwanted interference outside the isolated areas. This object and others are achieved by the methods and nodes according to the independent claims, and by the embodiments according to the dependent claims.

In accordance with a first embodiment, a method in a radio network node of a communications system, for controlling a UE's transmission in cells of a first frequency band is provided. The cells of the first frequency band are intended only for UE in an isolated area. The method comprises receiving a measurement report from the UE comprising a list of measured cells. The list of measured cells comprises cells of the first frequency band, and cells of a second frequency band providing coverage both in the isolated area and in an area outside the isolated area. The method also comprises allowing the UE to transmit in one of the cells of the first frequency band, if all cells in the list of measured cells provide coverage only in the isolated area.

In accordance with a second embodiment, a method in a UE of a communications system, for controlling the UE's transmission in a cell of a first frequency band, is provided. The cell of the first frequency band is intended only for UE in an isolated area. Cells of a second frequency band provide coverage both in the isolated area and in an area outside the isolated area. The method comprises receiving information from a radio network node controlling the cell of the first frequency band, the information indicating that the cell of the first frequency band is allowed for transmission only when the UE is connected to the radio network node. The method also comprises attempting a reconnection to a cell of the second frequency band, based on the received information, when losing a connection to the radio network node.

In accordance with a third embodiment, a radio network node of a communications system, configured to control a UE's transmission in cells of a first frequency band, is provided. The cells of the first frequency band are intended only for UE in an isolated area. The radio network node comprises a receiver configured to receive a measurement report from the UE comprising a list of measured cells, wherein the list of measured cells comprises cells of the first frequency band, and cells of a second frequency band providing coverage both in the isolated area and in an area outside the isolated area. The radio network node also comprises a processing circuit configured to allow the UE to transmit in one of the cells of the first frequency band, if all cells in the list of measured cells provide coverage only in the isolated area.

In accordance with a fourth embodiment, a UE of a communications system, configured to control the UE's transmission in a cell of a first frequency band, is provided. The cell of the first frequency band is intended only for UE in an isolated area. Cells of a second frequency band provide coverage both in the isolated area and in an area outside the isolated area. The UE comprises a receiver configured to receive information from a radio network node controlling the cell of the first frequency band. The information indicates that the cell of the first frequency band is allowed for transmission only when the UE is connected to the radio network node. The UE also comprises a processing circuit configured to attempt a reconnection to a cell of the second frequency band, based on the received information, when losing a connection to the radio network node.

An advantage of embodiments is that an increased capacity is provided in the isolated areas in a cost efficient way, without risking interference in areas outside the isolated areas. The capacity may be increased by an approximate factor of two to five, depending on the number of additional frequency bands that can be utilized.

Other objects, advantages and features of embodiments will be explained in the following detailed description when considered in conjunction with the accompanying drawings and claims.

### BRIEF DESCRIPTION OF THE DRAWINGS

FIG. 1a-b are schematic illustrations of radio access networks.

FIG. 2 is a schematic illustration of a subway environment with a deployment of leaky cables.

FIGS. 3a-c are flowcharts illustrating the method in a radio network node according to embodiments.

FIG. 4 is a flowchart illustrating the method in a UE according to embodiments.

FIGS. 5a-b are block diagrams schematically illustrating a radio network node according to embodiments.

FIG. 5c is a block diagram schematically illustrating a radio network node and a UE according to embodiments.

### DETAILED DESCRIPTION

In the following, different aspects will be described in more detail with references to certain embodiments and to accompanying drawings. For purposes of explanation and not limitation, specific details are set forth, such as particular scenarios and techniques, in order to provide a thorough understanding of the different embodiments. However, other embodiments that depart from these specific details may also exist.

Moreover, those skilled in the art will appreciate that the functions and means explained herein below may be implemented using software functioning in conjunction with a programmed microprocessor or general purpose computer, and/or using an application specific integrated circuit (ASIC). It will also be appreciated that while the embodiments are primarily described in the form of methods and nodes, they may also be embodied in a computer program product as well as in a system comprising a computer processor and a memory coupled to the processor, wherein the memory is encoded with one or more programs that may perform the functions disclosed herein.

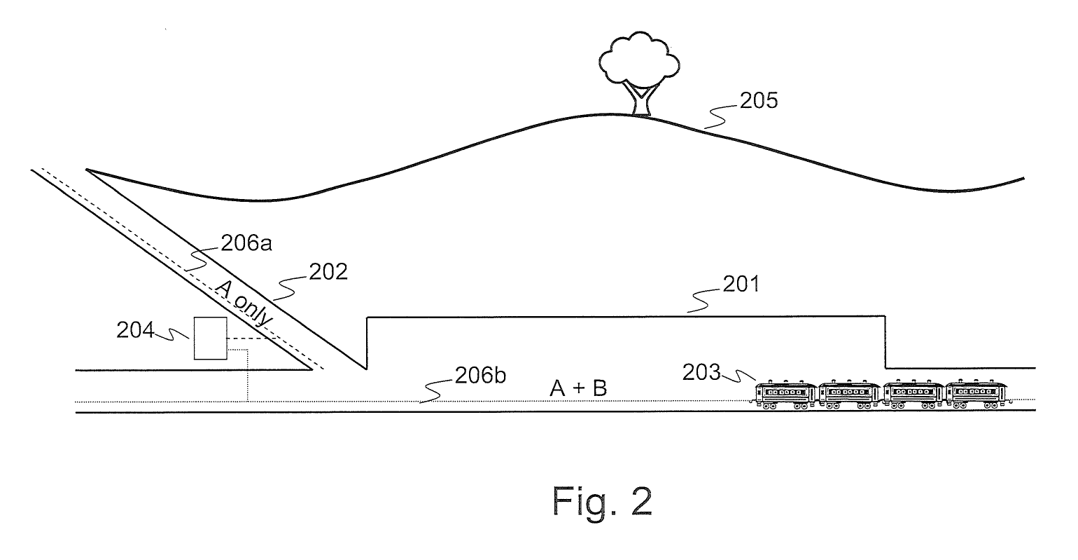

Embodiments are described in a non-limiting general context in relation to an example scenario with a radio access network providing coverage in a subway in two frequency bands, such as the scenario illustrated in FIG. 2. However, it should be noted that the embodiments may also be applied to other types of isolated areas, such as inside a building. Furthermore, embodiments are not limited to just two frequency bands, and frequency bands of any types of radio access networks and combination of radio access networks may be used.

The problem of providing a higher capacity in a cost efficient way in isolated areas such as subways is addressed by a solution where one or more additional frequency bands are deployed in the subway. The additional frequency bands may be bands where transmissions are not allowed in general, e.g. due to risk of interference towards a primary spectrum license holder operating above ground. By making sure that relevant handovers are trigged at the right places, a good coverage and capacity may be assured in the subway while maintaining regulatory requirements and user experience. It is thus ensured that UEs which are located where there is a risk that interference towards other systems could be generated, as well as the RBSs communicating with such UE's, will not use the additional frequency bands.

Regulatory authorities around the world decide what frequency bands that are allowed to be used for mobile communication in different parts of the world. The decisions are based on the interference situation with other kinds of systems either within a country or between countries. In for example Sweden, the GSM networks are deployed at 900 and 1800 MHz, but not at 850 or 1900 MHz. However, in order to make it possible to use a UE world-wide, a UE often support frequency bands for more than one part of the world. As an example, a mobile phone may support GSM at 850/900/1800/1900 MHz and UMTS at 800/850/1900/2100 MHz or 900/2100 MHz.

In order to increase capacity in a radio communications system deployed in the subway or in any other radio isolated area, it may thus be possible to use some of the frequency bands that have been allocated to other services by the regulatory authorities, provided that no harmful interference towards these other services is generated. In general, it is very difficult to avoid such interference. However a closed environment such as a subway is very well isolated, and therefore offers an advantage since the interference can be contained below ground. A potential interference may therefore be minimized and even avoided. If it can be guaranteed that the use of an additional frequency band will not generate any interference towards other systems, the regulatory authorities may allow opening up the use of this frequency band in e.g. the subway for the cellular operators.

In order to provide good coverage in a transition zone between the isolated area and a “normal” area outside the isolated area, and at the same time minimize or avoid transmissions in frequency bands interfering with the frequency bands used by other services above ground in the normal area, Inter-Frequency Handover (IFHO) and possibly Inter Radio Access Technology Handover (IRATHO) need to be triggered at the right places.

This is in one embodiment achieved according to the process described hereinafter. In the following, a first frequency band is the additional frequency band intended only for UE's located in the isolated area. A second frequency band is the regular frequency band which is thus intended for any UE regardless of if it is located within or outside the isolated area. Cells of the second frequency band may thus provide coverage both in the isolated area and in an area outside the isolated area, while cells of the first frequency band are intended only for UEs in an isolated area.

During network planning, the network is configured with two different classes of cells: a first class of cells comprising cells covering only isolated areas and a second class of cells comprising all other cells. The second class of cells comprises cells covering areas outside the isolated areas, or cells covering both isolated areas and areas outside the isolated areas. An underground cell of the second frequency band may thus be identified as a cell covering only an isolated area. The class of a cell may in one embodiment be indicated in the list of neighbour cells. In this way the radio network node can know what cells in the list of neighbor cells that are covering only isolated areas and base its handovers on that knowledge, as explained herein. In one example embodiment, the class of a cell is indicated by a flag for each cell in the list of neighbour cells. Alternatively, the information about the class of a cell may be explicitly exchanged between the radio network nodes, such that a radio network node is informed about the class of any neighbour cell that is controlled by a neighbour radio network node. In GSM/UMTS, the BSCs/RNCs may e.g. exchange information about cell classes, and in LTE the exchange may be done between eNBs over the X2 interface.
1. In general, no cells of the first additional frequency band are present in any neighbor cell lists in the cells of the regular network of the second frequency band. A cell of the first frequency band is placed in the neighbor cell list of a cell of the regular network only if that cell is an underground cell, i.e. a cell of the second frequency band covering an area that has a very high isolation towards the outside. In this way the radio network node controlling a cell of the second frequency band has knowledge about if the cell covers only an isolated area or if it covers areas above ground as well.
2. For a UE which is served by a cell of the second frequency band, handovers to a cell of the first frequency band are initiated based on state of the art IFHO or IRATHO, under condition that the UE hears or reports a cell in the additional first frequency band and a cell of the regular second frequency band with a cell of the first frequency band in its neighbor cell list (which is thus a cell covering only an isolated area). No other cells of the second frequency band than cells with a cell of the first frequency band in its neighbor cell list may be heard by the UE, as that would mean that the UE hears a cell covering an area outside the isolated area, and thus could in turn interfere with other systems when transmitting on the first frequency band. Handovers to a cell in the first frequency band are thus barred if the UE hears or reports any cells other than underground cells.
3. Furthermore, for a UE which is served by a cell of the first frequency band, a handover to a cell of the second frequency band is triggered as soon as the UE hears or reports any cells other than underground cells.
4. If the radio network node loses connection with a UE operating in a cell of a first frequency band, a mechanism that makes the UE avoid any transmissions in the first frequency band is needed to avoid prohibited interference. This may be achieved by blindly issuing a zero scheduling grant, or by blindly initiating an IFHO or IRATHO. The radio network node would in this way, although it has no connection with the UE any longer, try to stop the UE from continuing to use the first frequency band for its transmissions, by telling the UE that it has no radio resources for transmission (zero scheduling grant), or that it should perform a handover to a cell of the second frequency band. If the connection with the UE is lost due to an uplink limited channel while the downlink is not affected, the UE may very well anyhow receive the zero scheduling grant or the handover command from the radio network node, and interference is thus avoided.
5. If the UE loses connection with a cell of the first frequency band, there is a risk that the UE will attempt to reconnect to the cell of the first frequency band, although the UE may be moving towards the border of the isolated area, and should normally not be allowed to transmit on the first frequency band any longer. In one embodiment, the UE is thus not allowed to attempt to re-connect to the protected frequency in this situation. This will however require an implementation that affects the standardized interface between a UE and the network.

Preferably, each cell of the first frequency band is designed to have a coverage area that:
a) Does not extend into areas where the usage of the first frequency band is prohibited, such as above ground in the subway scenario.
b) Ensures hearability of one or several regular underground cells throughout the coverage area. This should not be an issue since it wouldn't make sense to deploy only the first frequency band and not the second regular one in the isolated area.

Nevertheless, actual coverage often differs from predicted coverage and therefore a deployment according to these principles is not a guarantee that harmful interference in the first frequency band will not be generated above ground.

In a further embodiment, the need for handover from the additional first frequency band to the regular second frequency band may be predicted by using positioning methods and/or knowledge of a particular network deployment.

In one example scenario, a subway train travelling beneath the ground contains a number of users with UEs that have been allocated to the additional first frequency band. In one section along the subway track, the subway enters into open air, and all of the UEs transmitting in a cell of the first frequency band will have to be handed over to a cell of the second frequency band at the same time. This may result in late handovers, as large amounts of handovers are initiated simultaneously which may delay the handovers due to capacity problems.

In order to avoid the risk of unwanted emissions from a UE performing a late handover, some form of positioning information could be used to detect that the train is approaching this section, and to trigger a handover to the regular frequency band. The positioning information may include information about, e.g.:
Doppler spread, which may indicate a moving train as opposed to a human walking on a platform;
The received signal strength of the UE, which may indicate the distance from the receiving antennas to the UE;
Cells that the UE was connected to in the past. A subway train will move linearly from cell to cell making it relatively easy to predict when it will approach a particular section.

The knowledge of the particular deployment may, e.g., include the locations of open-air sections of the track, and the typical times between a train leaving the platform and entering the open-air section.

For the subway scenario, a possible deployment of a regular frequency band A and an additional frequency band B is illustrated in FIG. 2. Cells covering the tunnels and the train platforms 201 should be served by both the regular and the additional frequency band, A+B, but the stairway 202 up from the platform 201 should be served by the regular frequency band A only. Consequently, IRATHO or IFHO is triggered somewhere in the stairway 202. From a capacity point of view, this means that all passengers in a passing train 203 would benefit from the improved capacity provided by the additional frequency band B, whereas people walking up or down from the platform 201 in the stairway 202 would not. This would be an acceptable situation since a passing train typically requires much more simultaneous capacity than people who are entering or exiting the platform.

In one example embodiment, the regular frequency band A deployed both outside and within the isolated subway area is GSM 1800, and the frequency band B added to increase the capacity within the isolated subway area is GSM 1900. A user has an ongoing speech connection using his UE over GSM 1800 on the ground 205, outside the subway area. The user then walks down in the subway. On the platform 201, the radio network detects congestion on the GSM 1800 band and initiates a load based IFHO to GSM 1900 which is deployed in the subway, but not on the ground. This is possible as the UE only hears underground cells. If the call is still ongoing when the user walks up from the subway, an IFHO is initiated in the stairway 202 as the UE starts to report ground cells and thus needs to handover to GSM 1800 in order not to provide interference outside the isolated area. If there is no GSM deployment on 1900 MHz but instead UMTS 1900, IRATHO may instead be initiated from GSM 1800 to UMTS 1900.

In one embodiment, the regular and the additional frequency bands are transmitted in the same leaky cable or distributed antenna system, but the additional frequency band is filtered out when coming close to the border of the isolated subway area. This may be realized with a leaky cable which has the property of radiating in the regular frequency band but not in the additional frequency band, or with passive components such as filters and splitters.

FIG. 2 illustrates the subway scenario where an RBS 204 serves two different leaky cables, 206a and 206b. The leaky cable covering the platform and the tunnels 206b is used for frequency bands A and B, where frequency band A is assumed to be the regular frequency band and frequency band B is assumed to be the additional frequency band. The leaky cable serving the stairway 206a is used for frequency band A only, in order to not create any prohibited band B interference in the area outside the isolated subway area. As described above, both frequency bands may in embodiments alternatively be transmitted in the same leaky cable. When moving between the platform and the stairway, an IFHO or IRATHO is triggered.

The advantage of described embodiments is that no extra leaky cables are required. Furthermore, the connectivity is maintained while moving between the subway and the ground. The only necessary network additions are radio network node hardware. Support is already available in the UEs, as they have support for being used in different frequency bands as explained above. One exception is the embodiment where the RBS tells the UE not to reconnect to the additional frequency band B if it loses connection with the RBS during a connection over band B, as such an embodiment requires a change in the UE.

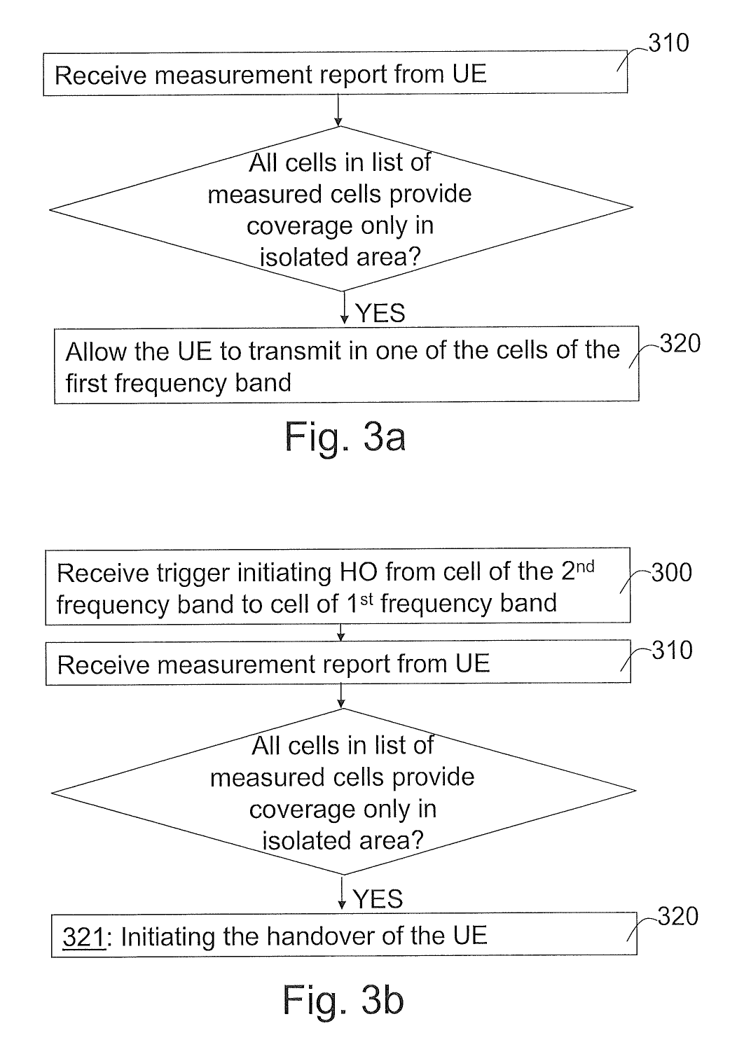

FIG. 3a is a flowchart illustrating a first embodiment of a method in a radio network node of a communications system, for controlling a UE's transmission in cells of a first frequency band. The radio network node may be a BSC, an RNC or an eNB, depending on the radio access network deployed. The cells of the first frequency band are intended only for UEs in an isolated area. This is thus the additional frequency band, corresponding to band B in FIG. 2. The isolated area is in one embodiment a radio isolated area with a high path loss between transmitters in the radio isolated area and receivers outside the radio isolated area. The isolated area may e.g. be a subway area as in FIG. 2, or an area inside a building. The method comprises:
310: Receiving a measurement report from the UE comprising a list of measured cells. The list of measured cells comprises cells of the first frequency band, and cells of a second frequency band providing coverage both in the isolated area and in an area outside the isolated area. The second frequency band is thus the regular frequency band. A cell of the second frequency band is a cell of the regular network which thus covers areas everywhere on the ground, as well as areas as the stairways leading to the subway, and isolated areas in the subway tunnels or platforms.
320: Allowing the UE to transmit in one of the cells of the first frequency band, if all cells in the list of measured cells provide coverage only in the isolated area.

In one embodiment, the radio network node has information regarding which cells of the second frequency band that provide coverage only in the isolated area. Said information may be provided in a neighbour cell list associated with a cell of the second frequency band, as already explained under bullet 1 in the example scenario previously described. The cell provides coverage only in the isolated area when the neighbour cell list comprises cells of the first frequency band. By planning the cells such that a cell of the first frequency band is placed in the neighbor cell list of a cell of the second frequency band only if the cell of the second frequency band covers an isolated area, the radio network node is thus provided with information regarding which cells of the second frequency band that provide coverage only in the isolated area.

FIG. 3b is a flowchart illustrating a second embodiment of the method. The UE is in this second embodiment served by a cell of the second frequency band. The embodiment corresponds to the description under bullet 2 in the previous example scenario. The method comprises:
300: Receiving a trigger initiating a handover of the UE to a cell of the first frequency band.
310: Receiving a measurement report from the UE comprising a list of measured cells. The list of measured cells comprises cells of the first frequency band, and cells of a second frequency band providing coverage both in the isolated area and in an area outside the isolated area.

The step 320 of allowing the UE to transmit in one of the cells of the first frequency band comprises:
321: Initiating the handover of the UE to a cell of the first frequency band comprised in the list of measured cells, if all cells in the list of measured cells provide coverage only in the isolated area.

FIG. 3c is a flowchart illustrating a third embodiment of the method. The UE is in this third embodiment initially served by a cell of the first frequency band. The embodiment corresponds to the description under bullets 3-5 in the previous example scenario. The method comprises:
310: Receiving a measurement report from the UE comprising a list of measured cells. The list of measured cells comprises cells of the first frequency band, and cells of a second frequency band providing coverage both in the isolated area and in an area outside the isolated area.
320: Allowing the UE to transmit in one of the cells of the first frequency band, if all cells in the list of measured cells provide coverage only in the isolated area. The UE is thus allowed to still use the first frequency band, as it cannot hear any cells covering areas outside the isolated area.
330: Initiating a handover of the UE to a cell of the second frequency band, if at least one of the cells in the list of measured cells provides coverage in the area outside the isolated area. If the UE suddenly starts to report cells covering areas outside the isolated area, the UE has to be handed over to the second frequency band to avoid interference.
340: If the radio network node loses connection with the UE, the radio network node will initiate a blind handover of the UE to a cell of the second frequency band, or issue a blind zero grant for the UE. This is done to avoid the risk that the UE is moving towards the outside area, still using the first frequency band and thus generating interference.
350: Transmitting information to the UE indicating that the serving cell of the first frequency band is allowed for transmission only when the UE is connected to the radio network node. If the UE will lose connection with the radio network node, the UE will thus know that it should try to reconnect to a cell of the second frequency band and not to the first frequency band.

In the first or the third embodiment, the method may optionally further comprise:
Retrieving information related to positioning of the UE, and/or to a deployment of the isolated area. The information may comprise e.g. Doppler spread information, information about signal strengths, or information about cells that the UE was connected to in the past. In the subway scenario, the information may also comprise locations of open-air sections of the subway track, and the typical times between a train leaving the platform and entering the open-air section.
Determining whether the UE is moving towards a boundary of the isolated area based on the retrieved information.
Initiating a handover of the UE to a cell of the second frequency band if the UE is moving towards the boundary of the isolated area. In this way, the risk of performing late handovers and thus causing interference outside the isolated area is minimized.

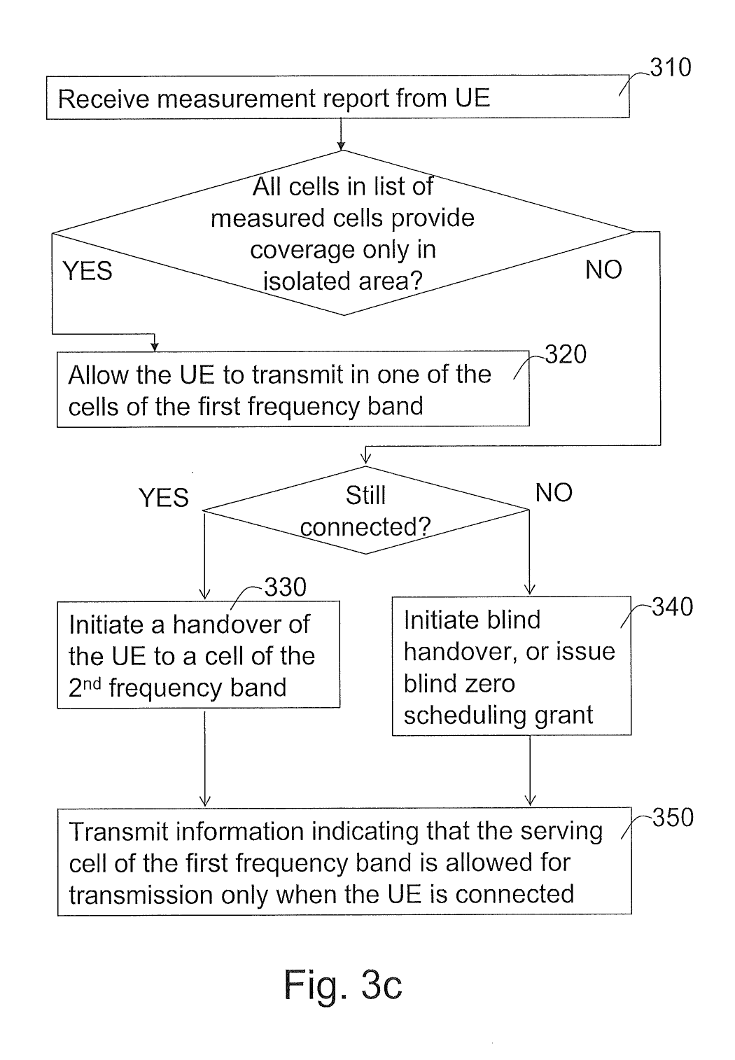

FIG. 4 is a flowchart illustrating a method in a UE of a communications system, for controlling the UE's transmission in a cell of a first frequency band, according to the third embodiment. As already described above, the cell of the first frequency band is intended only for UE in an isolated area. Cells of the second frequency band provide coverage both in the isolated area and in an area outside the isolated area. The UE is in this third embodiment served by a cell of the first frequency band. The method comprises:
410: Receiving information from a radio network node controlling the cell of the first frequency band, the information indicating that the cell of the first frequency band is allowed for transmission only when the UE is connected to the radio network node. This corresponds to step 350 of the method in the radio network node.
420: When losing a connection to the radio network node, attempting a reconnection to a cell of the second frequency band, based on the received information. In this way, the UE will never attempt a reconnection to the previous serving cell of the first frequency band if it loses connection with the network, and the risk for prohibited interference outside the isolated area is minimized.

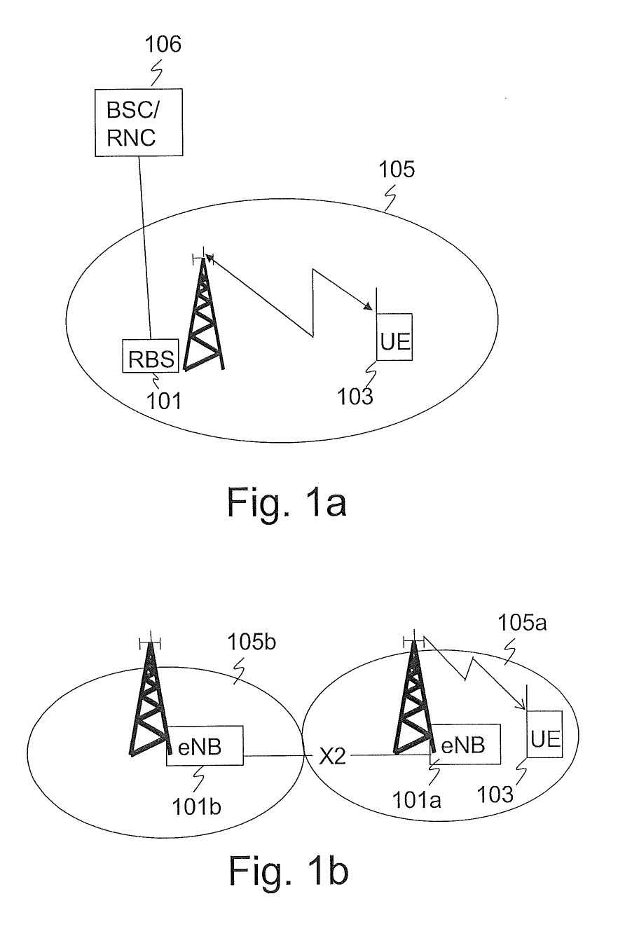

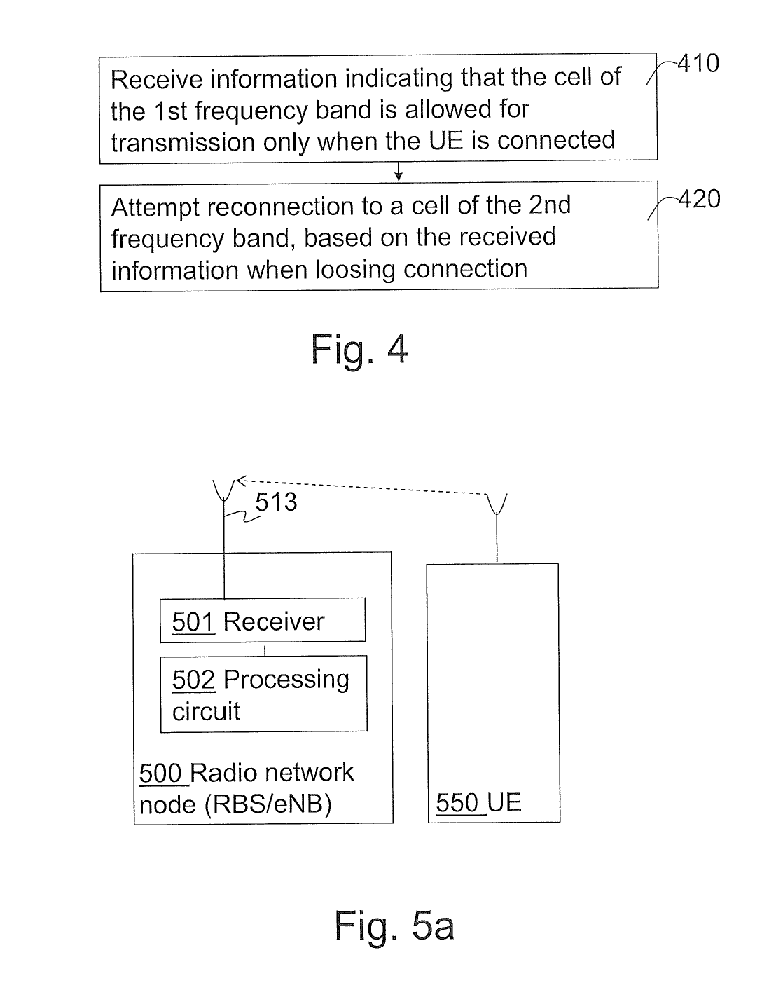

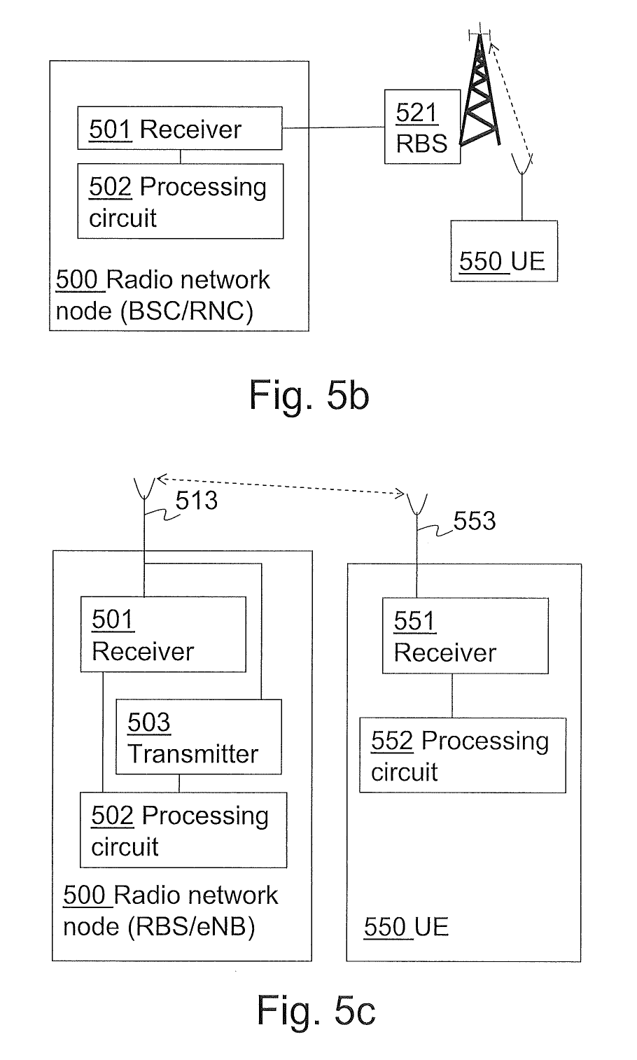

An embodiment of a radio network node 500 of a communications system, configured to control a UE's 550 transmission in cells of a first frequency band, is schematically illustrated in the block diagram in FIG. 5a. In this example embodiment, the radio network node 500 is an RBS such as the eNB in an LTE radio access network illustrated in FIG. 1b. The cells of the first frequency band are intended only for UEs in an isolated area. The first frequency band is thus the additional frequency band. The isolated area is in one embodiment a radio isolated area with a high path loss between transmitters in the radio isolated area and receivers outside the radio isolated area. The isolated area may e.g. be a subway area or an area inside a building. The radio network node 500 comprises a receiver 501 configured to receive a measurement report from the UE 550 comprising a list of measured cells. The list of measured cells comprises cells of the first frequency band, and cells of a second frequency band providing coverage both in the isolated area and in an area outside the isolated area. The second frequency band is thus the regular network. The radio network node 500 also comprises a processing circuit 502 configured to allow the UE 550 to transmit in one of the cells of the first frequency band, if all cells in the list of measured cells provide coverage only in the isolated area.

Another example embodiment of a radio network node 500 is schematically illustrated in the block diagram in FIG. 5b, where the radio network node 500 is a BSC in a GSM radio access network, or an RNC in a UMTS radio access network. In this example embodiment, the radio network node 500 also comprises the processing circuit 502 and the receiver 501 described with reference to FIG. 5a. However, the receiver 501 is configured to receive the measurement report from the UE 550, via an RBS 521.

In an alternative way to describe the embodiments in FIG. 5a and in FIG. 5b, the radio network node 500 comprises a Central Processing Unit (CPU) which may be a single unit or a plurality of units. Furthermore, the radio network node 500 comprises at least one computer program product (CPP) in the form of a non-volatile memory, e.g. an EEPROM (Electrically Erasable Programmable Read-Only Memory), a flash memory or a disk drive. The CPP comprises a computer program, which comprises code means which when run on the radio network node 500 causes the CPU to perform steps of the procedure described earlier in conjunction with FIG. 3a. In other words, when said code means are run on the CPU, they correspond to the processing circuit 502 of FIG. 5a/5b.

In one embodiment, the radio network node 500 has information regarding which cells of the second frequency band that provide coverage only in the isolated area. Said information may be provided in a neighbour cell list associated with a cell of the second frequency band. The cell provides coverage only in the isolated area when the neighbour cell list comprises cells of the first frequency band. By planning the cells such that a cell of the first frequency band is placed in the neighbor cell list of a cell of the second frequency band only if the cell of the second frequency band covers an isolated area, the radio network node is thus provided with information regarding which cells of the second frequency band that provide coverage only in the isolated area.

The receiver 501 is in the second embodiment further configured to receive a trigger initiating a handover of the UE 550 to a cell of the first frequency band when the UE is served by a cell of the second frequency band. The processing circuit 502 is configured to initiate the handover of the UE to a cell of the first frequency band comprised in the list of measured cells, if all cells in the list of measured cells provide coverage only in the isolated area

In the third embodiment schematically illustrated in the block diagram in FIG. 5c, the radio network node 500, which in this example is an eNB in LTE, is configured to handle the case when the UE 550 is initially served by a cell of the first frequency band. The processing circuit 502 is configured to initiate a handover of the UE 550 to a cell of the second frequency band, if at least one of the cells in the list of measured cells provides coverage in the area outside the isolated area. The processing circuit 502 may be further configured to initiate a blind handover of the UE to a cell of the second frequency band, or issuing a blind zero grant for the UE, if the radio network node loses connection with the UE. The radio network node 500 may also comprise a transmitter 503 configured to transmit information to the UE e.g. via an antenna 513 combined with the receiving antenna, indicating that the serving cell of the first frequency band is allowed for transmission only when the UE is connected to the radio network node. If the radio network node is a BSC or an RNC, the transmitter 503 is configured to transmit information to the UE via the RBS serving the UE 550.

In the first or the third embodiment, the processing circuit 502 may optionally be further configured to:
Retrieving information related to positioning of the UE, and/or to a deployment of the isolated area. The information may comprise e.g. Doppler spread information, information about signal strengths, or information about cells that the UE was connected to in the past. In the subway scenario, the information may also comprise locations of open-air sections of the subway track, and the typical times between a train leaving the platform and entering the open-air section.
Determining whether the UE is moving towards a boundary of the isolated area based on the retrieved information.
Initiating a handover of the UE to a cell of the second frequency band if the UE is moving towards the boundary of the isolated area. In this way, the risk of performing late handovers and thus causing interference outside the isolated area is minimized.

In the block diagram in FIG. 5b, the UE 550 is illustrated in accordance with the third embodiment. The UE 550 is configured to control the UE's transmission in a cell of a first frequency band. Normally, the radio network controls the UE's transmissions, but this embodiment covers the situation when the UE has lost connection with the network. The cell of the first frequency band is intended only for UEs in an isolated area, and cells of a second frequency band provide coverage both in the isolated area and in an area outside the isolated area. The UE comprises a receiver 551 configured to receive information from a radio network node 500 controlling the cell of the first frequency band. The information may be received via the antenna 558. The information indicates that the cell of the first frequency band is allowed for transmission only when the UE is connected to the radio network node. The UE 550 also comprises a processing circuit 552 configured to attempt a reconnection to a cell of the second frequency band, based on the received information, when losing a connection to the radio network node.

In an alternative way to describe the embodiment in FIG. 5b, the UE 550 comprises a Central Processing Unit (CPU) which may be a single unit or a plurality of units. Furthermore, the UE 550 comprises at least one computer program product (CPP) in the form of a non-volatile memory, e.g. an EEPROM (Electrically Erasable Programmable Read-Only Memory), a flash memory or a disk drive. The CPP comprises a computer program, which comprises code means which when run on the UE 550 causes the CPU to perform steps of the procedure described earlier in conjunction with FIG. 4. In other words, when said code means are run on the CPU, they correspond to the processing circuit 552 of FIG. 5b.

The circuits described above with reference to FIG. 5a-b may be logical circuits, separate physical circuits or a combination of both logical and physical circuits.

The above mentioned and described embodiments are only given as examples and should not be limiting. Other solutions, uses, objectives, and functions within the scope of the accompanying patent claims may be possible.

1. A method in a radio network node of a communications system, for controlling a user equipment's transmission in cells of a first frequency band, wherein the cells of the first frequency band are intended only for user equipment in an isolated area, the method comprising:
receiving a measurement report from the user equipment comprising a list of measured cells, wherein the list of measured cells comprises cells of the first frequency band, and cells of a second frequency band providing coverage both in the isolated area and in an area outside the isolated area, and
allowing the user equipment to transmit in one of the cells of the first frequency band, based on all cells in the list of measured cells providing coverage only in the isolated area.

2. The method according to claim 1, wherein the user equipment is served by a cell of the second frequency band, the method further comprising:
receiving a trigger initiating a handover of the user equipment to a cell of the first frequency band,
wherein allowing the user equipment to transmit in one of the cells of the first frequency band comprises:
initiating the handover of the user equipment to a cell of the first frequency band comprised in the list of measured cells, based on all cells in the list of measured cells providing coverage only in the isolated area.

3. The method according to claim 1, wherein the user equipment is served by a cell of the first frequency band, the method further comprising:
initiating a handover of the user equipment to a cell of the second frequency band, based on at least one of the cells in the list of measured cells providing coverage in the area outside the isolated area.

4. The method according to claim 1, wherein the user equipment is served by a cell of the first frequency band, the method further comprising:
initiating a blind handover of the user equipment to a cell of the second frequency band, or issuing a blind zero grant for the user equipment, based on the radio network node losing connection with the user equipment.

5. The method according to claim 3, further comprising:
transmitting information to the user equipment indicating that the serving cell of the first frequency band is allowed for transmission only when the user equipment is connected to the radio network node.

6. The method according to claim 1, further comprising:
retrieving information related to positioning of the user equipment, and/or to a deployment of the isolated area,
determining whether the user equipment is moving towards a boundary of the isolated area based on the retrieved information, and
initiating a handover of the user equipment to a cell of the second frequency band based on the user equipment is moving towards the boundary of the isolated area.

7. The method according to claim 1, wherein the radio network node has information regarding which cells of the second frequency band that provide coverage only in the isolated area.

8. The method according to claim 7, wherein said information is provided in a neighbour cell list associated with a cell of the second frequency band, and wherein the cell provides coverage only in the isolated area when the neighbour cell list comprises cells of the first frequency band.

9. The method according to claim 1, wherein the isolated area is a radio isolated area with a high path loss between transmitters in the radio isolated area and receivers outside the radio isolated area.

10. The method according to claim 1, wherein the isolated area is a subway area or an area inside a building.

11. A method in a user equipment of a communications system, for controlling the user equipment's transmission in a cell of a first frequency band, wherein the cell of the first frequency band is intended only for user equipment in an isolated area, and wherein cells of a second frequency band provide coverage both in the isolated area and in an area outside the isolated area, the method comprising:
receiving information from a radio network node controlling the cell of the first frequency band, the information indicating that the cell of the first frequency band is allowed for transmission only when the user equipment is connected to the radio network node, and
when losing a connection to the radio network node, attempting a reconnection to a cell of the second frequency band, based on the received information.

12. A radio network node of a communications system, configured to control a user equipment's transmission in cells of a first frequency band, wherein the cells of the first frequency band are intended only for user equipment in an isolated area, the radio network node comprising:
a receiver configured to receive a measurement report from the user equipment comprising a list of measured cells, wherein the list of measured cells comprises cells of the first frequency band, and cells of a second frequency band providing coverage both in the isolated area and in an area outside the isolated area, and
a processing circuit configured to allow the user equipment to transmit in one of the cells of the first frequency band, based on all cells in the list of measured cells providing coverage only in the isolated area.

13. The radio network node according to claim 12, wherein the receiver is further configured to receive a trigger initiating a handover of the user equipment to a cell of the first frequency band when the user equipment is served by a cell of the second frequency band, and wherein the processing circuit is configured to initiate the handover of the user equipment to a cell of the first frequency band comprised in the list of measured cells, based on all cells in the list of measured cells providing coverage only in the isolated area

14. The radio network node according to claim 12, wherein the processing circuit is configured to initiate a handover of the user equipment to a cell of the second frequency band, based on at least one of the cells in the list of measured cells providing coverage in the area outside the isolated area, when the user equipment is served by a cell of the first frequency band.

15. The radio network node according to claim 12, wherein the processing circuit is further configured to initiate a blind handover of the user equipment to a cell of the second frequency band, or issuing a blind zero grant for the user equipment, based on the radio network node losing connection with the user equipment, when the user equipment is served by a cell of the first frequency band.

16. The radio network node according to claim 14, further comprising a transmitter configured to transmit information to the user equipment indicating that the serving cell of the first frequency band is allowed for transmission only when the user equipment is connected to the radio network node.

17. The radio network node according to claim 12, wherein the processing circuit is further configured to:
retrieve information related to positioning of the user equipment, and/or to a deployment of the isolated area,
determine whether the user equipment is moving towards a boundary of the isolated area based on the retrieved information, and
initiate a handover of the user equipment to a cell of the second frequency band based on the user equipment is moving towards the boundary of the isolated area.

18. The radio network node according to claim 12, wherein the radio network node has information regarding which cells of the second frequency band that provide coverage only in the isolated area.

19. The radio network node according to claim 18, wherein said information is provided in a neighbour cell list associated with a cell of the second frequency band, and wherein the cell provides coverage only in the isolated area when the neighbour cell list comprises cells of the first frequency band.

20. The radio network node according to claim 12, wherein the isolated area is a radio isolated area with a high path loss between transmitters in the radio isolated area and receivers outside the radio isolated area.

21. The radio network node according to claim 12, wherein the isolated area is a subway area or an area inside a building.

22. A user equipment of a communications system, configured to control the user equipment's transmission in a cell of a first frequency band, wherein the cell of the first frequency band is intended only for user equipment in an isolated area, and wherein cells of a second frequency band provide coverage both in the isolated area and in an area outside the isolated area, the user equipment comprising:
a receiver configured to receive information from a radio network node controlling the cell of the first frequency band, the information indicating that the cell of the first frequency band is allowed for transmission only when the user equipment is connected to the radio network node, and
a processing circuit configured to attempt a reconnection to a cell of the second frequency band, based on the received information, when losing a connection to the radio network node.
